(19) United States
(12) Patent Application Publication
(10) Pub. No.: US 2007/0137352 A1
(43) Pub. Date: Jun. 21, 2007

(54) Apparatus and method for a terbo worm gear with teeth extending below the centerline of the worm

(76) Inventor: Terry Allan Hrushka, Cannington (CA)

Correspondence Address: Galasso & Associates, LP, P.O. Box 26503, Austin, TX, 78755-0503, US

(21) Appl. No.: 11/287,835

(22) Filed: Nov. 28, 2005

(51) Int. Cl. F16H 1/16

(52) U.S. Cl. 74/425

(57) ABSTRACT

A terbo gear is provided for efficient use in a worm gear set, using more than one quarter of the worm's diameter as an effective work area. Each tooth on the terbo gear engages the helical thread of the drive worm just below the centerline of the worm, which reduces run-out deflection of the worm and greatly enhances the contact area of every tooth during rotational thrust. A configuration with a worm sandwiched between two terbo gears greatly reduces climb-out deflection of the worm as well, for high load applications. A small, low-power motor can thus create a massive output torque at a very low RPM through the use of a worm gear. The worm gear may be manufactured efficiently and inexpensively by riveting together pre-stamped laminated washers of various sizes to form a blank. Blanks may then be roll-form cut, for example by using either a mandrel with roll-form inserts or a roll-form tap.

### FIELD OF THE DISCLOSURE

The present invention relates to worm gears and more particularly to a terbo gear for efficient use in a worm gear set.

### BACKGROUND

A worm gear is a type of gear used to reduce speed or to allow torque to be transmitted between non-intersecting axles. As shown in FIG. 1, a standard worm gear comprises a worm 2, which is a rod with a screw thread, and a gear 4 in the form of a toothed wheel that meshes with the screw thread of the worm 2. For each complete turn of the worm shaft, the gear shaft advances only one tooth of the gear. Also, the axis of rotation is turned by 90 degrees. Unlike with ordinary gears, the motion of a worm gear 4 is not reversible, due to the greater friction involved; a worm 2 can drive a gear 4 to reduce speed but a gear 4 cannot drive a worm 2 to increase it. This can be an advantage when it is desired to eliminate any possibility of the output driving the input. As the speed is reduced, the torque to the drive increases correspondingly. Worm gears 4 are a compact, efficient means of substantially decreasing speed and increasing torque.

Worm gears are currently are not widely used in mechanical applications because of their high manufacturing costs. Each standard worm gear set, i.e. both the worm 2 and the gear 4, must be manufactured in an expensive process based on its end use and load/speed requirements, to reduce deflection such as run out, which is when the worm 2 bends out away from the center of the gear teeth towards the outside edge of the gear 4.

A standard worm gear obtains strength through a uniquely cut helix in the worm and the small pressure angle of each tooth in the gear. FIG. 2, a right side view, shows how a standard worm gear 4 typically only makes use of a limited contact area 6 of less than one quarter of the diameter of its worm 2. Although this configuration provides smooth operation, large working loads are not possible with worm gears because of the high deflection of the worm 2, which thus results in the loss of drive integrity and safety the device is utilized in.

Therefore, there is a need for a worm gear with a design that makes use of more than one quarter of its diameter as an effective work area, so that the worm is deflected less and thus loses less drive integrity, increasing safety and efficiency. In addition there is a need for less expensive methods of manufacturing worm gears and the utilization of coupled worm drives to expand the use thereof within future applications.

### SUMMARY OF THE DISCLOSURE

The following explanation describes the present invention by way of example and not by way of limitation.

It is an aspect of the present invention to provide a worm gear with a design that makes use of more than one quarter of its diameter as an effective work area, whereby the rotational force applied is evenly distributed by the pressure angle of the helix on the worm to the gear teeth, thus increasing drive integrity.

It is an another aspect of the present invention to provide a worm gear set that uses two terbo gears to reduce warble and harmonic resonance when the worm is rotating above 10,000 RPM. This method greatly increases output capabilities and decreases worm run-out, vibration and wear. The worm is unable to disengage the gear teeth under excessive load conditions, which greatly improves the safety factor of the drive system.

It is yet another aspect of the present invention to provide a gear blank comprising entirely of prefabricated washers, laminated and riveted together for manufacturing one or more worm gears by roll-form cutting or through the current scope of manufacturing by Hob cutting.

It is still another aspect of the present invention to provide a method for manufacturing one or more worm gears by roll-form cutting rather than Hobbing and lapping as conventional worm gears are cut.

These and other aspects of the present invention will become readily apparent upon further review of the following specification and associated drawings. In accordance with the present invention, a terbo gear is provided for efficient use in a worm gear set, using more than one quarter of the worm's diameter as an effective work area. Each tooth on the terbo gear engages the helical thread of the drive worm just below the centerline of the worm, which reduces run-out deflection of the worm and greatly enhances the contact area of every tooth during rotational thrust. A configuration with a worm sandwiched between two terbo gears greatly reduces climb-out deflection of the worm as well, for high load applications. A small, low-power motor can thus create a massive output torque at a very low RPM through the use of a worm gear. The worm gear may be manufactured efficiently and inexpensively by riveting together pre-stamped laminated washers of various sizes to form a blank. Blanks may then be roll-form cut, for example by using either a mandrel with roll-form inserts or a roll-form tap.

### BRIEF DESCRIPTION OF THE DRAWINGS

The following embodiments of the present invention are described by way of example only, with reference to the accompanying drawings, in which:

FIG. 1 is a perspective diagram that illustrates a front view of a standard conventional worm gear, showing its area of contact with a worm;

FIG. 2 is a perspective diagram that illustrates a right side view of a standard conventional worm gear, showing its area of contact with a worm;

FIG. 3 is a perspective diagram that illustrates a terbo gear;

FIG. 4 is a perspective diagram that illustrates a front view of two terbo gears, showing their area of contact with a worm;

FIG. 5 is a perspective diagram that illustrates a right side view of two terbo gears, showing their area of contact with a worm;

FIG. 6 is a perspective diagram that illustrates the use of multiple worm gears with a worm;

FIG. 7 is a perspective diagram that illustrates the use of two terbo gears in a drive train;

FIG. 8 is a flow chart that illustrates a block process for manufacturing one or more worm gears.

FIG. 9 is a perspective diagram that illustrates a set of pre-stamped, laminated washers that may be riveted together or spot welded to form a blank for manufacturing a terbo gear;

FIG. 10 is a perspective diagram that illustrates a finished laminated a terbo gear with rivets in place;

FIG. 11 is a flow chart that illustrates a process for riveting together pre-stamped washers to form a terbo gear;

FIG. 12 is a perspective diagram that illustrates a mandrel with a roll-form insert;

FIG. 13 is a perspective diagram that illustrates a roll-form tap;

FIG. 14 is a perspective diagram that illustrates a system for manufacturing terbo gears, with a mounted mandrel;

FIGS. 15A and 15B represent a flow chart that illustrates a process for manufacturing terbo gears from proprietary blanks;

FIG. 16 is a perspective diagram that illustrates a system for manufacturing terbo gear, with a mounted roll-form tap;

FIG. 17 is a perspective diagram that illustrates live centers screwed in tightly to each of the hub locations on gear blanks for manufacturing terbo gears;

FIG. 18 a perspective diagram that illustrates live centers with shaft seals to seal out coolant and debris from live center bearings;

FIG. 19 is a perspective diagram that illustrates a right side view of a machined terbo gear blank; and

FIG. 20 is a perspective diagram that illustrates a machined terbo gear blank.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements, as well as the order of steps in processes, are shown in diagrams for clarity, as examples only and not as limitations of the present invention.

The present invention comprises
A terbo gear with a design that makes use of more than one quarter but less than half of its diameter as an effective work area, whereby the rotational force applied is evenly distributed by the pressure angle of the helix on the worm to the gear teeth, thus increasing drive integrity;
A worm gear set comprising a worm and two terbo gears; and
An efficient and inexpensive method of manufacturing terbo gears.
   Terbo Gear

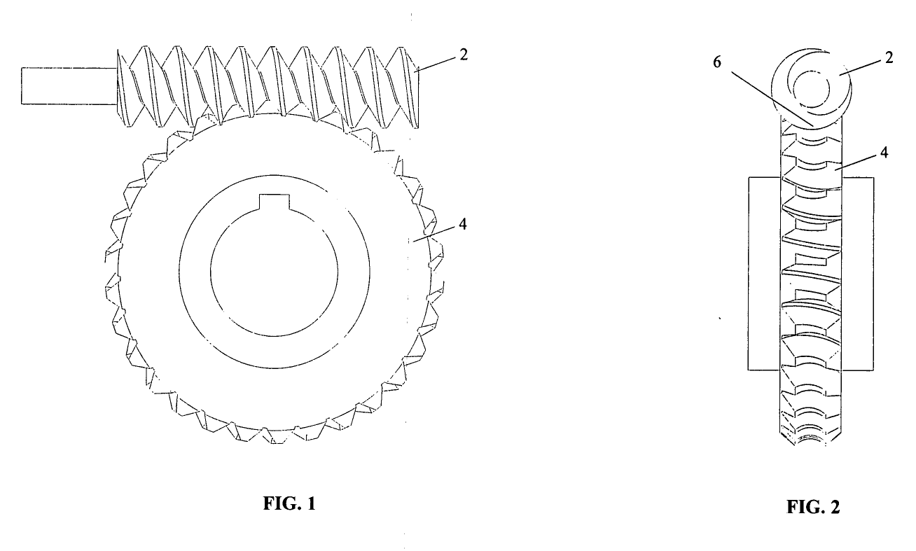

As shown in FIG. 3, a terbo gear 10 is a worm gear designed so that each tooth on the gear blank extends slightly below the centerline of the worm 2. The particular example of terbo gear 10 in FIG. 3 is designed to be utilized with a threaded worm sized as M8×1.25 mm thread pitch. Each tooth on the gear 10 engages each thread of the worm 2 1 mm. or more below the centerline of a given worm 2. This means that in this example the teeth on the terbo gear 10 are in full contact with seven threads on the worm 2 (one during lead-in, five under thrust and one during lead-out) of each rotation of the worm 2. The greater the overall diameter of each terbo gear 10, the greater the number of contact threads; thus, the overall rotational force applied to each tooth is evenly distributed, providing a greater safety factor than a conventional worm gear, shown in FIG. 1, does. Tooth size and depth on any given terbo gear 10, shown in FIG. 3, is dependent on the size and thread pitch of the roll-forming tool used to manufacture the terbo gear 10. The load capabilities of any terbo gear 10 are dependant on two factors inherent to its design:
The size and thread pitch of forming tool used; and
The size and support bearings necessary to embody the terbo gear 10 into a functional gear train.

The contact area on conventional worm gears relies on large helical threads, and significantly less contact is made, resulting in stress failure during overload.

As with standard gears, a terbo gear 10 comprises a beveled edge 12 to allow the penetration and flow of lubricant around the teeth of the terbo gear 10. Detail A shows an expanded view of the beveled edge 12. This ensures adequate circulation of lubricant when embodied in a lubricant bath.

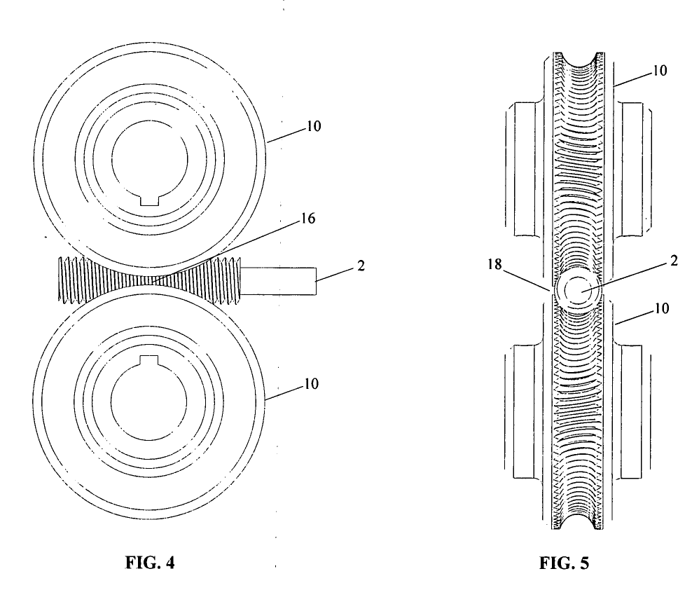

FIG. 4 shows that the configuration of a terbo gear 10 creates a contact area 16 between a worm 2 and the terbo gear 10 that is approximately twice that of a standard worm gear, shown in FIG. 1, because, as mentioned above, each tooth on the terbo gear 10, shown in FIG. 3, is formed on the gear blank slightly below the centerline of the worm 2. The worm 2 engages more of the teeth of the terbo gear 10, as shown in the contact area 16, than occurs with a standard gear, shown in FIG. 1.

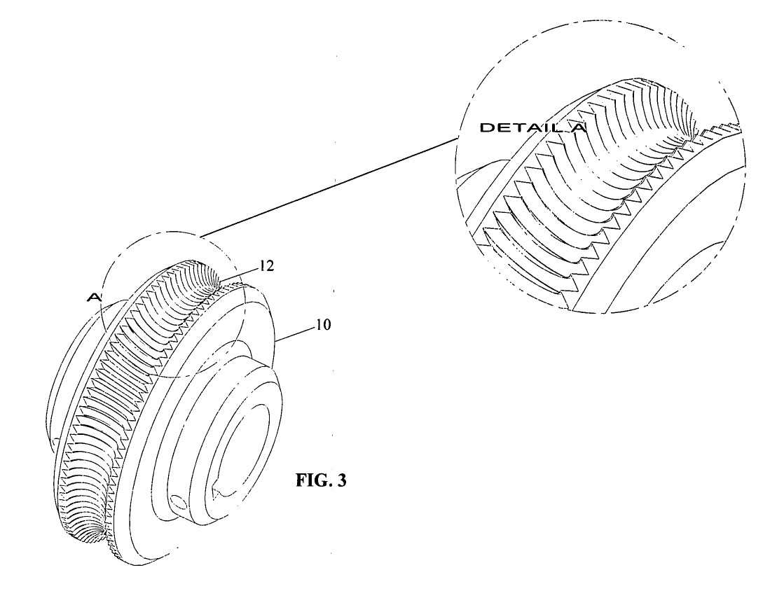

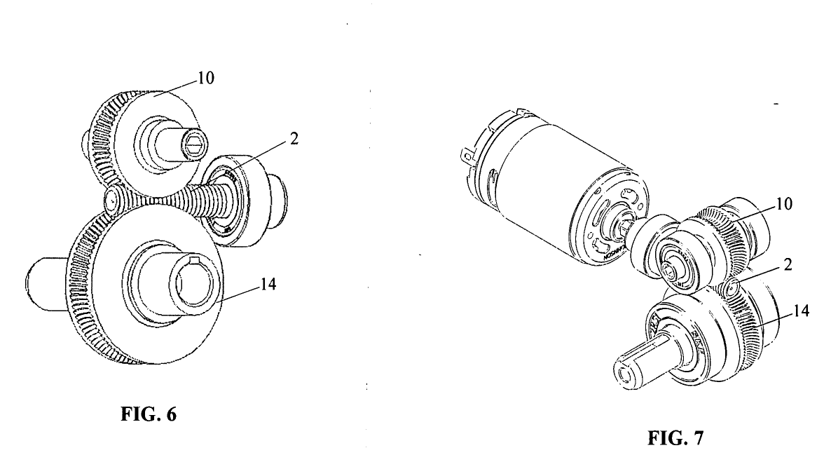

FIG. 5, a right view of a terbo gear 10, shows that the worm 2 also engages the teeth of the terbo gear 10 more deeply in the contact area 16, than occurs with a standard gear, shown in FIG.2, where only a small area of a single helix of the worm has contact with the teeth of the worm gear.

The use of a terbo gear 10, shown in FIG. 3, in a worm gear set thus creates greater torque transfer and reduces the likeliness of the run out effects than a standard worm gear 4, shown in FIG. 1, experiences in high RPM and load instances. As mentioned above, run out refers to when the worm 2 bends out away from the center of the gear teeth towards the outside edge of the gear 4, and it can cause failure of the drive train. Because the teeth on a terbo gear 10, shown in FIG. 3, are shorter than those of a standard worm gear 4, shown in FIG. 1, less run out occurs with a terbo gear 10, shown in FIG. 3.

Utilizing high-speed motors operating above 30,000 RPM, a system using one or more terbo gears 10 can be produced to drive systems that require high torques with a minimal amount of input energy. As a result, a very small, low-power motor can create a massive output torque at a very low RPM, through the use of two terbo gears 10, depending on size and bearing support systems.

The main reason that the high loads are obtainable through use of one or more terbo gears 10 in a worm gear set is because the worm 2 typically engages the terbo gear 10 at approximately 1 mm. or more below the center line of the worm 2, as shown in area 16 in FIG. 5. Therefore, the surface contact of each tooth in the terbo gear 10 with the worm 2 is just below half the diameter of the worm. In a typical embodiment resulting from roll-form cutting, for example, the 30° pressure angle face of each thread of the worm 2 is in full contact with each tooth during rotation, providing high loads with little deflection of the worm 2 and thus maintaining drive integrity.

When used with one or more terbo worm having common standard or metric thread fastener, lead or power screw pitches, machined into a usable drive mechanism. In such a configuration, the worm 2 is the wear component for rapid and easy replacement in an embodied mechanism. In an embodiment, the terbo gear 10 is manufactured from high quality tool steels, hardened to withstand harsh industrial work hours. For example, the wear life of a terbo gear 10 manufactured from pre-hardened 4140 steel could be nearly unlimited if properly maintained and lubricated. In the case of high load applications, malleable tool steels should be utilized as blanks and then should be roll-formed and hardened. Lapping of the terbo gear would be necessary only after a hardening process.

In other embodiments, the terbo gear can be manufactured out of plastic, soft metal such as aluminum, brass, or exotic high quality tool steels, depending on the product in which the terbo gear will be utilized. For example, terbo gears in small toys could utilize hard plastics such as Delrin, ABS, and PVC. Possible uses of terbo gears are unlimited, but terbo gears are not intended for use as or part of a safety device.

Use of Two Terbo Gears

In an embodiment shown in FIG. 6, a worm 2 is sandwiched between two terbo gears 10 and 14 to reduce warble and harmonic resonance while the drive worm 2 is rotating above 10,000 RPM. Although it is not necessary to utilize both terbo gears 10 and 14 as functional output devices, one or the other terbo gear 10 or 14 is necessary as an idler and stabilizer. When used in a power train, as shown in FIG. 7, the terbo gears 10 and 14 can rotate at a relatively high RPM, withstand extreme load forces and obtain high ratios of input to output, and are cost effective to manufacture.

The use of two terbo gears 10 and 14 in a drive train greatly reduces both run out, as explained above, and climb out, so that the efficiency and power transfer of the drive train are greatly increased. Climb out is when the worm bends up away from the gear teeth, and it too can cause failure of the drive train. The use of two terbo gears 10 and 14 in a drive train serves to hold the worm 2 in place so that it cannot bend as far away from the gear teeth as with standard gears. This configuration of two terbo gears 10 and 14 is very useful for high load applications.

An advantage of using one or more terbo gears 10 and 14 as a drive method in a worm gear is the fact that terbo gears 10 and 14 as can be manufactured for a limited number of standard configurations of worm gears, so that a specific worm 2 and terbo gears 10 and 14 do not have to be manufactured for use together. For example, terbo gears 10 can be manufactured in common configurations, such as the following:
An M12×1.75 mm. pitch for standard uses in a few standard ratios,
An M30×3.5 mm. pitch for mid-range applications, and
An M68×6 mm. pitch for use in extreme machines.

A recommended lubrication specification for terbo gear arrangements is Shell Omala 220 gear oil or equivalent mixed with a 5% ratio of Power Up NNL-690G Additive in an oil bath during full load operation.

The terbo gear 10 design is not intended for use in any application where safety is an issue. Although the unique design of the terbo gear 10 is a zero backlash system, external provisions must be taken into account when being utilized as a lifting device whereby the terbo gear 10 must withstand continual force in an idle capacity. It is recommended that application sizing of the terbo gear be undertaken by a professional engineer when utilized in a lifting or pulling apparatus.

Terbo Gear Manufacturing Process

Prior manufacturing methods for worm gears require the use of CNC (Computerized Numerically Controlled) machinery and special hobbing cutters to manufacture both the worm and the gear portion of the sets, normally a matched set of gears. The gears are cut from prefabricated gear blanks.

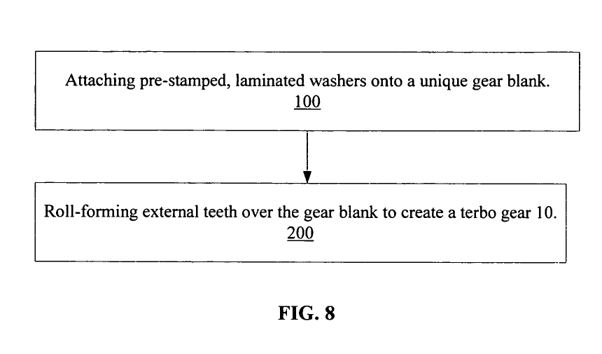

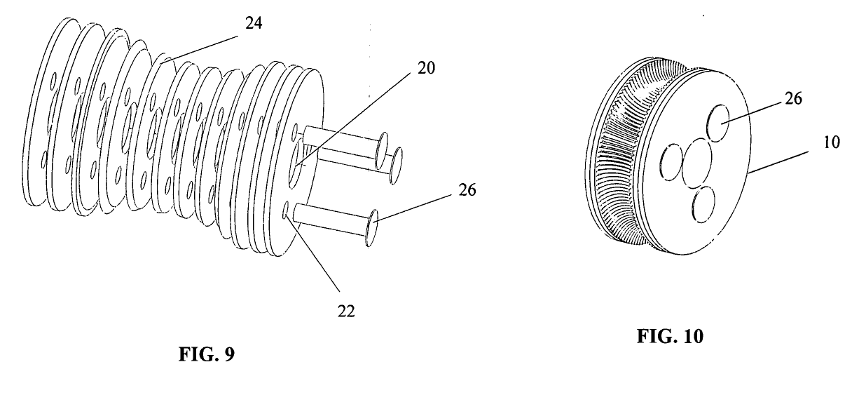

Although these prior methods may be used to manufacture terbo gears 10, the present invention comprises a faster and less expensive method, without the use of expensive CNC machinery and special hobbing cutters. As shown in FIG. 8, these methods comprise
Step 100 in FIG. 8—Manufacturing a unique gear blank, and
Step 200 in FIG. 8—Roll-forming external teeth over the gear blank to create a terbo gear 10.
   Manufacturing a Unique Gear Blank

In an embodiment, two methods may be used to manufacture a unique gear blank for further manufacturing a terbo gear:
Attaching pre-stamped washers onto a gear blank, and
Machining the gear blank.
   Attaching Pre-Stamped Washers onto a Gear Blank

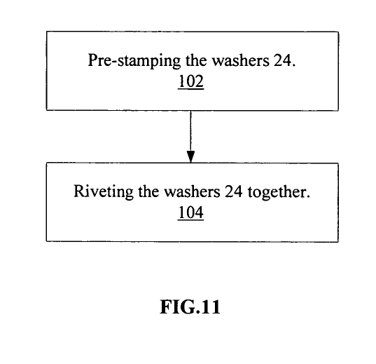

In an embodiment, a series of pre-stamped, laminated washers 24, shown in FIG. 9, of various sizes may be attached together with rivets 26 to form a terbo gear blank, which may then be roll formed to create a terbo gear 10, shown in FIG. 3. In an embodiment each washer 24, shown in FIG. 9, contains a pierced hub center 20 and three rivet holes 22. The material thickness of each washer 24 is dependent on the size and material tensile strength required for the application of the terbo gear 10, shown in FIG. 3, to be produced. FIG. 10 shows a finished, laminated terbo gear 10 with the rivets 26 in place. FIG. 11 shows the steps involved in this process:
Step 102 in FIG. 10—Pre-stamping the washers 24. Washers are manufactured for the correct configuration of a gear blank.
Step 104 in FIG. 10—Riveting the washers 24 together.

In another embodiment, a series of pre-stamped, laminated washers 24, shown in FIG. 9, of various sizes may be spot welded together to form a terbo gear blank

A gear blank can thus be machined to any size without the complex mathematics involved in calculating a standard worm gear, making this method less labor intensive and less expensive.

Machining the Gear Blank

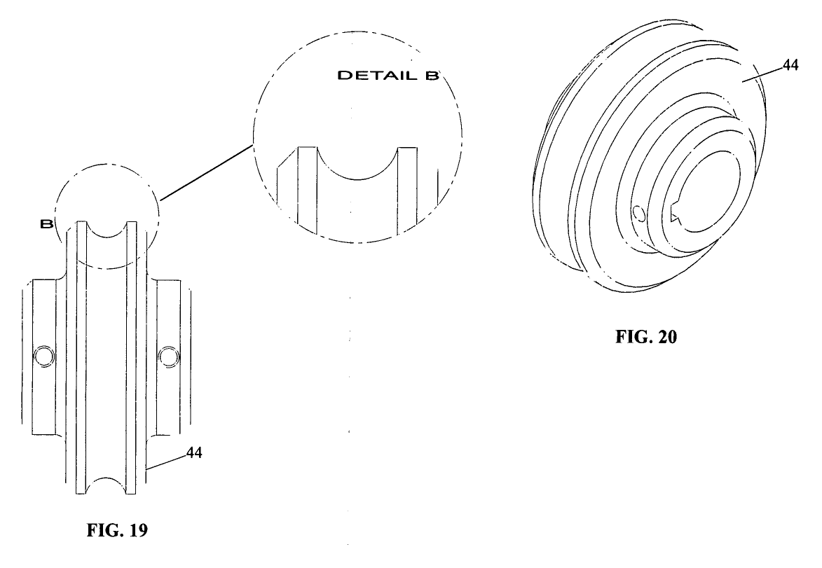

A uniquely designed, machined gear blank 44 for a terbo gear is shown in FIG. 19. The method of machining such a gear blank may be performed by CNC lathe, or in the case of plastic gear blanks, by means of a molding system. The size of the cut radius depends on following a tap drill chart for a roll-form tap. The depth of the radius cut should be based on the tap drill radius minus the 1 mm. clearance from centerline of worm. As an example; the terbo gear 10 in FIG. 3 is based on an M8×1.25 mm. pitch roll-form tap or mandrel insert. Therefore, the necessary radius is 3.4 mm.; or if one was to look on a tap drill chart, it would state that the necessary drill size for an M8 tap is 6.8 mm. (radius=½ diameter) and the depth would be 3.4 mm.-1 mm. clearance from centerline of worm (depth=2.4 mm). The outside radius of the gear blank should be such that at lease 1 mm. clearance exists below centerline of worm. FIG. 20 shows a further view of a machined gear blank 44.

Roll-Forming External Teeth over the Gear Blank

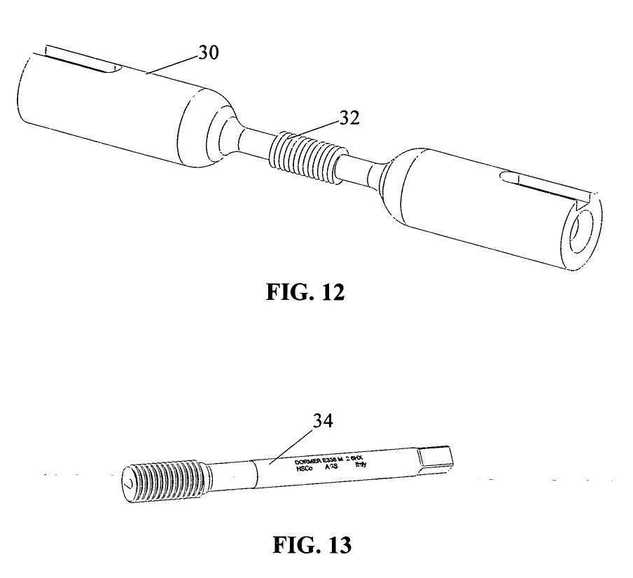

After a unique gear blank has been formed from the laminated washers, a terbo gear 10, shown in FIG. 3, may be manufactured by roll forming an external thread over the gear blank 44 without the need for complex and expensive machining operations. Any imperial, metric or Acme roll-form tap of any thread pitch can be used to form a terbo gear 10, shown in FIG. 3. For example, two types of taps useful for creating terbo gear teeth from gear blanks are the following:
A mandrel 30 containing an interchangeable roll-form insert 32, shown in FIG. 12.
The roll-form insert 32 can be used to create various sizes of terbo gears 10.
Note that in very precise worm gear systems, the mandrel insert should be changed once the forming process is complete and replaced with a lapping insert to smooth out and polish the finished teeth on the terbo Gear.
A standard roll-form tap 34 (jobber quality), as shown in FIG. 13.
   A Roll Forming Process

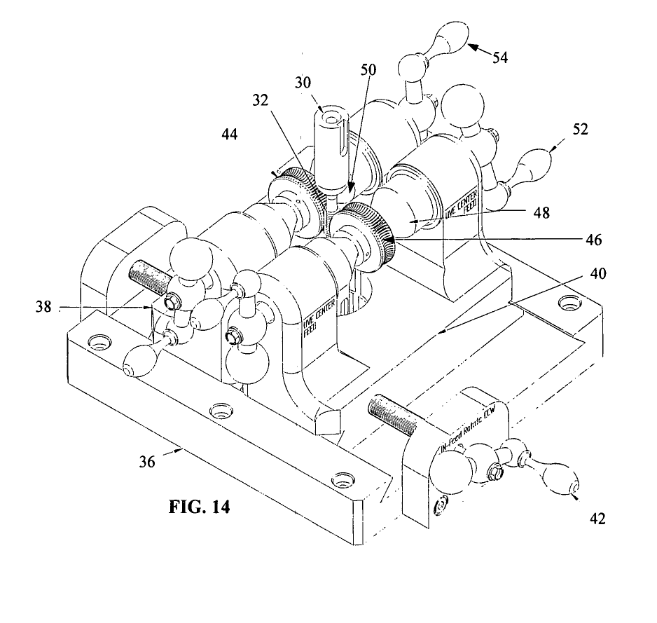

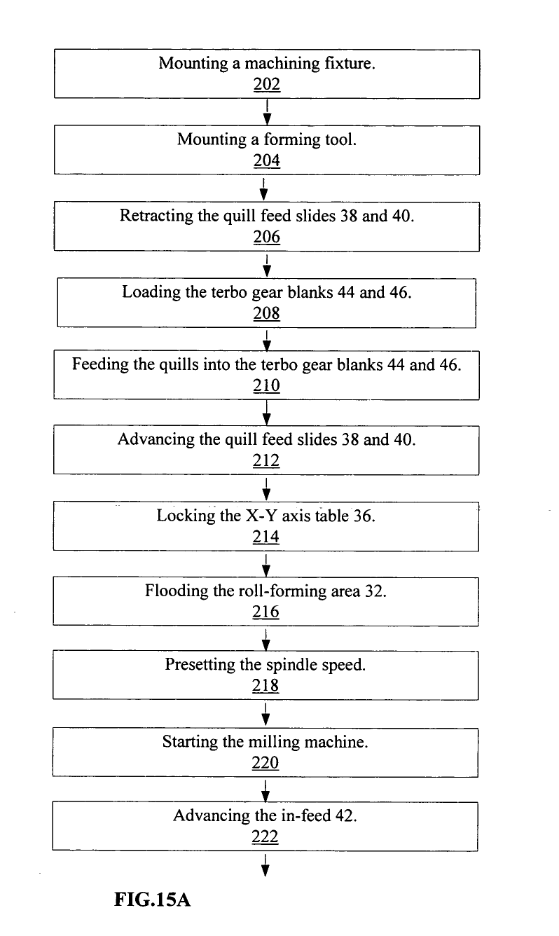

FIG. 14 shows an example of a roll-forming process for one or more terbo gears. The best and most accurate method to create teeth on the gear blank is to manufacture a specific mandrel 30 containing an interchangeable roll-form insert 32.

The second and most cost effective method is utilizing a standard roll-form tap (jobber quality) 34, shown in FIG. 13. This method, although cost effective, has inherent problems such as deflecting because the bottom of the tap is unsupported. This will cause efficiency issues within a gear train.

Note that the roll-forming insert 32, shown in FIG. 12, or the roll-form tap 34, shown in FIG. 13, must not contain cutting flutes or chip removal slots, which can cause uneven tooth height in the terbo gear 10, shown in FIG. 3.

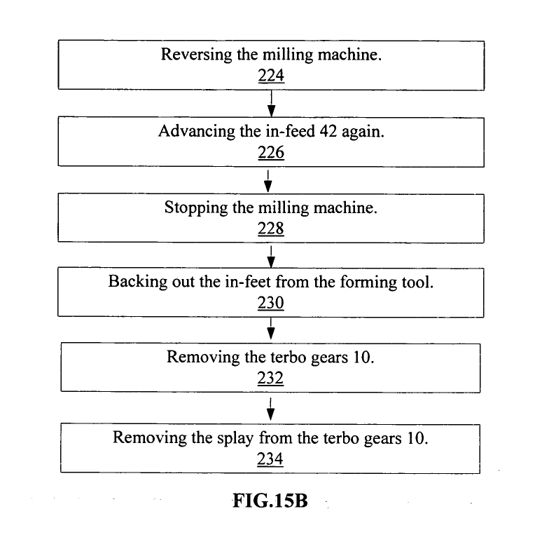

FIGS. 15A and 15B show an embodiment of a process for using the system presented in FIG. 14, with the following steps:

Step 202 in FIG. 15A—Mounting a Machining Fixture.

A machining fixture is mounted on an X-Y axis table 36, shown in FIG. 14, of a vertical milling machine. The fixture base consists of a dovetail slide system to maintain precise movement of quill feed slides 38 and 40.

Step 204 in FIG. 15A—Mounting a Forming Tool.

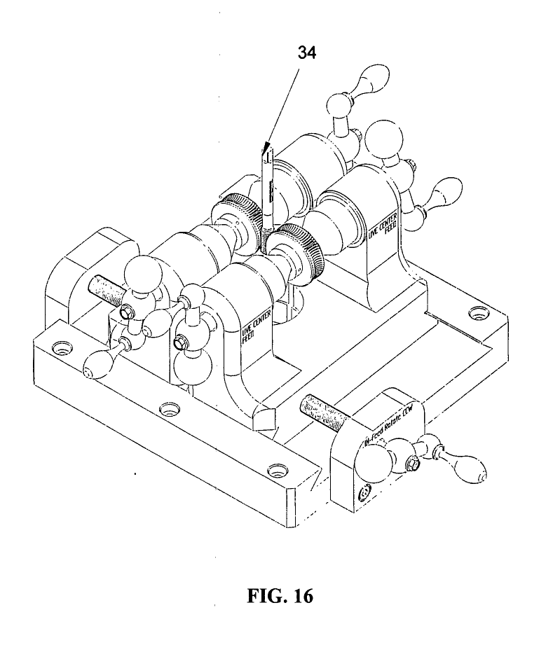

A forming tool, such as a mandrel 30, shown in FIG. 14, or roll-form tap 34, shown in FIG. 13, is selected to match a pre-manufactured terbo gear blank 44. The forming tool is mounted in a collette assembly in the quill of the vertical milling machine. The setup must ensure that the forming tool is centered and running true. FIG. 16 shows a mounted roll-form tap 34.

Step 206 in FIG. 15A—Retracting the Quill Feed Slides 38 and 40.

The in-feed 42, shown in FIG. 14, is rotated clockwise to retract both quill feed slides 38 and 40 simultaneously. The in-feed lead screw is a left and right hand precision screw supported by thrust bearings on each end.

Step 208 in FIG. 15A—Loading the Terbo Gear Blanks 44 and 46.

Terbo gear blanks 44 and 46, shown in FIG. 14, of identical size are loaded manually one at a time held in position by hand against the live center 48 and 50 in the hub of the gear blank 44 and 46. Two gear blanks 44 and 46 can thus be manufactured simultaneously, for fast, efficient processing and to ensure equal lateral pressure is applied to roll forming tool.

Step 210 in FIG. 15A—Feeding the Quills into the Terbo Gear Blanks 44 and 46.

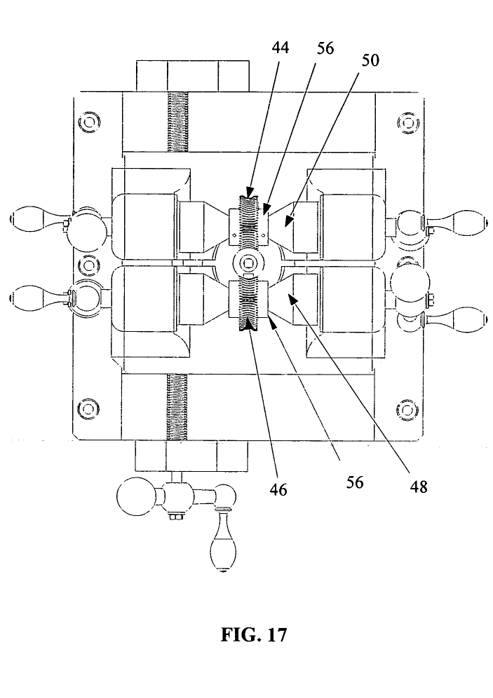

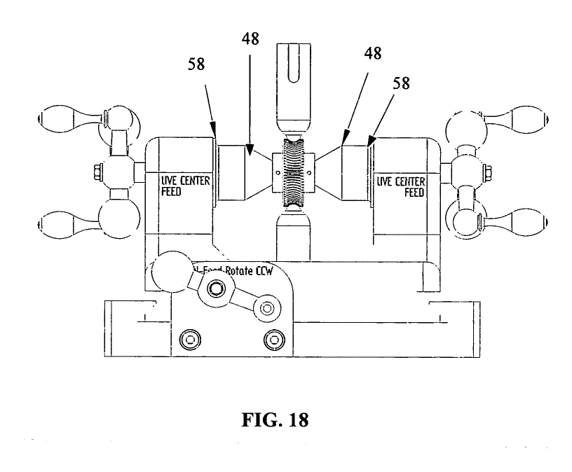

Each of the four quills are fed into the hubs of two terbo gear blanks 44 and 46, shown in FIG. 14, by rotating handles 52 and 54 clockwise. The live centers 48 and 50, shown in FIG. 17, must be screwed in tightly to each of the hub locations 56, on the terbo gear blanks 44 and 46. The centers must be predetermined according to size of the terbo gear 10, shown in FIG. 3, being formed. The live centers 48, shown in FIG. 18, each consist of dual support bearing and an internal thrust bearing. They must have shaft seals 58 to prevent the entrance of cutting oil.

Step 212 in FIG. 15A—Advancing the Quill Feed Slides 38 and 40.

The in-feed 42, shown in FIG. 14, is rotated counter-clockwise which in turn advances the quill feed slides 38 and 40 into the forming tool, for example into the mandrel 30. The centering of the terbo gear blanks 44 and 46 can then be verified.

Step 214 in FIG. 15A—Locking the X-Y Axis Table 36.

The X-Y axis table 36, shown in FIG. 14, of the vertical mill is locked to prevent movement.

Step 216 in FIG. 15A—Flooding the Roll-Forming Area 32.

The roll-forming area 32, shown in FIG. 14, of the forming tool, either of the mandrel 30 or of the roll-form tap 34, shown in FIG. 13, must be flooded in cutting fluid prior to startup of the milling machine.

Step 218 in FIG. 15A—Presetting the Spindle Speed.

The spindle speed of the milling machine should be preset to rotate at 1200 RPM. The higher the RPM, the greater the wear of the roll-forming insert 32, shown in FIG. 14. The larger the diameter of the roll-forming insert 32 utilized, the slower in RPM the spindle must rotate.

Step 220 in FIG. 15A—Starting the Milling Machine.

The milling machine is then started so the forming tool, for example the mandrel 30 shown in FIG. 14, turns in a clockwise rotation.

Step 222 in FIG. 15A—Advancing the In-Feed 42.

The in-feed 42 is then slowly advanced against the rotating forming tool, for example the mandrel 30, for a depth of one half of the thread depth of the selected insert size.

Step 224 in FIG. 15B—Reversing the Milling Machine.

The milling machine is then turned off, and then restarted in reverse.

Step 226 in FIG. 15B—Advancing the In-Feed 42 Again.

The in-feed 42, shown in FIG. 14, is then slowly advanced against the reversely rotating forming tool, for example the mandrel 30, for the last half of the thread depth. This method ensures that the teeth on the manufactured terbo gears 10, shown in FIG. 3, are evenly formed. The outside edges of the newly formed terbo gears 10 appear splayed out. This is normal because the teeth are being formed on the terbo gears 10 and are not being cut as is in conventional worm gear manufacturing.

For a terbo gear 10 having an outside diameter of 30 mm. or less, the entire process to form teeth on the terbo gear 10 takes less than 30 seconds, which is much less time than with prior methods of manufacturing worm gears. For example, the process may take 15 seconds in each direction. Naturally, the larger the terbo gear 10 being formed, the greater the cycle time involved.

Note that the farther the terbo gear blanks 44 and 46, shown in FIG. 14, are fed into the forming tool, for example into the mandrel 30, the smaller the diameter of the manufactured terbo gear 10, shown in FIG. 3, becomes, and the greater the splay area becomes on the edges of the terbo gear 10. Also, it is not necessary to manufacture an accurately round terbo gear blank 44, shown in FIG. 10. The forming process actually processes a perfectly round terbo gear 10, shown in FIG. 3.

Step 228 in FIG. 15B—Stopping the Milling Machine.

Once processing is complete, the milling machine must be stopped.

Step 230 in FIG. 15B—Backing Out the In-Feet from the Forming Tool.

The in-feed 42, shown in FIG. 14, is backed out away from the forming tool, for example out of the mandrel 30.

Step 232 in FIG. 15B—Removing the Splay from the Terbo Gears 10.

Both completed terbo gears blanks 44 and 46, shown in FIG. 14, are then removed from the system.

Step 234 in FIG. 15B—Removing the Splay from the Terbo Gears 10.

Both completed terbo gears are transferred to a lathe, and one at a time placed in lathe centers to remove the splay from each of their sides. They are each cleaned up then heat treated according to metal type utilized. The results are finished terbo gears 10, as shown in FIG. 3. Depending on the type of material and heat treating process, it might prove necessary to lap fit the hardened terbo gears by utilizing a special mandrel with a carbide thread chaser insert.

In this process each roll-form insert 32, shown in FIG. 14, can be rapidly changed when worn or replaced to accommodate various sizes of required terbo gears 10, shown in FIG. 3. The roll-form inserts 32, shown in FIG. 14, should be of a high quality carbide configuration to extend wear life. When a mandrel 30 is used, either end of the mandrel 30 can be the drive end. The other end of the mandrel 30 must be supported through the use of the spindle-bearing assembly contained within the fixture.

Other Roll-Forming Methods

In other embodiments, other methods of roll forming, known and not yet known, may be used to manufacture terbo gears from gear blanks, for example the following methods:
Commercially Purchased Fluteless Fastener Roll-Form Tap or Thread Rolling, Cold Forming. This device, as depicted in FIG. 13, is available in all BSW, BSF, BSPT, BSPP, BA, PG, ACME, SAE, ANSI, ISO, DIN, JIS and UNI size standards. Moreover, it may be modified to contain small ambiguous later or spiral cuts necessary to enhance cutting fluid effectiveness.
Commercially Purchased Fastener Thread Chaser Tap. This device is similar to that depicted in FIG. 13 and is available in all BSW, BSF, BSPT, BSPP, BA, PG, ACME, SAE, ANSI, ISO, DIN, JIS and UNI size standards, whether existing or not.
Commercially Purchased Fastener Thread Lapping Tap. This device is similar to that depicted in FIG. 13 but contains slightly larger threads to be utilized with lapping compound for polishing the sides of the threads, whether existing or not.
Commercially Purchased Thread Rolling Form Device. This device is available for Landis TRH, Alco, Acme-Fette and Fette thread rolling heads, Lanroll rolling attachments and thread rolling machines including but not limited to other manufacturers not mentioned above.
Custom Manufactured Mandrel system containing custom made or commercially purchased fluted or flute less Thread Rolling/Forming/Chasing inserts. The mandrel system may or may not comprise a multi-spindle configuration. This device, as depicted in FIG. 12, is available in all BSW, BSF, BSPT, BSPP, BA, PG, ACME, SAE, ANSI, ISO, DIN, JIS and UNI size standards.
Linear Dual Slide Mechanically or Hydraulically Driven Pressure Plates. These devices are similar in approach and or methodology of machine screw machines. Inset dies containing a thread pattern hydraulically or mechanically operating unilaterally; stamp an external thread around a gear blank through pressure applied in a liner motion.
   Applications

The following list cites examples of applications of terbo gear systems that are particularly useful because of the ability of terbo gear systems to produce a large amount of rotational power from a minimal energy source such as a small motor.

1. Wind Power Generation
Smaller scale impeller blades can be used to produce the same output as larger wind generators but in a smaller area. In this respect, multiple generating mills can be installed in the same real estate as one large one providing a multiplier of output capabilities. Solar cells mounted on each of the impeller blades can also be used to assist in power generation.

2. Air Compressor Drive Systems
Companies require huge amounts of compressed air to run their manufacturing machines. Through a terbo gear system, however, a 50 HP air compressor may only require a 20 HP drive system. This in turn will represent a huge decrease in production overhead.

3. Electric Driven Cars
A much smaller electric motor can be utilized on a variable speed basis in a much smaller package, providing less overall weight. Currently, car companies utilize sophisticated transmissions that are bulky and compromise safety for passengers because they have to keep the weight of the vehicle down to enhance distance on a battery charge.

4. Robotics
Increased payloads can be achieved in a smaller envelope.

5. Conveyors
Conveyors would require less drive power than is possible through conventional systems.

6. Indexing and positioning actuators. Pneumatic linear to rotary conversion actuators.
Backlash free operation can be achieved.

7. Bicycles.
Miniature-power assisted, battery-driven modules can be added to promote an increase of cyclists.

8. Toys, Battle Bots, Power Tools

9. A cost effective replacement to a Rack & Pinion device. A terbo gear can be utilized as a driven gear to act as a pinion and a threaded rod or lead screw can replace the rack portion. As an example, attach a simple hand crank to a terbo gear that rests over or under a threaded rod to traverse a carriage or slide table in machine tool applications.

Dimensions

The dimensions of terbo gears 10, shown in FIG. 3, in power transmissions may depend on their intended use in different applications. For example, some of the variables that would influence these dimensions are the input RPM/torque and desired gear ratio.

One of the obvious problems involved in the design of terbo gear power transmissions is selecting the correct bearings to handle the intended load. This single factor will ultimately determine the physical size of the housing. A drop-in cartridge similar to that of a planetary gear system may be a viable method of obtaining a variety of final drive ratios/thread sizes with a limited number of housings.

The best dimensional relationships for the parts of the invention described above, including variations in form and use, will be readily apparent to those skilled in the art, and are intended to be encompassed by the present invention.

What is claimed is:

1. A terbo gear for a worm gear set, such that each tooth on the terbo gear engages each thread of the worm 1 mm. or more below the centerline of the worm to use more than one quarter and less than half of the worm's diameter as an effective work area and reduce run-out deflection of the worm.

2. A terbo worm gear set that reduces the climb-out deflection of the worm when the worm is rotating at high RPM and or load, the terbo gear set comprising
at least one worm;
a first terbo gear that functions as an output device; and
a second terbo gear that functions as an idler and stabilizer.

3. A method of manufacturing a terbo gear, comprising
means of manufacturing a unique gear blank for a terbo gear; and
means of roll-forming external teeth over the gear blank to create a terbo gear.

4. The means of manufacturing a unique gear blank for a terbo gear of claim 3, wherein the of manufacturing a unique gear blank for a terbo gear comprises means of attaching a set of washers in pre-configured sizes, assembled and laminated together such that the set of washers comprises a gear blank for a terbo gear.

5. The means of attaching a set of washers of claim 4, where in the means of attaching a set of washers further comprises riveting the washers together.

6. The washers of claim 5, wherein each washer further comprises
a cutout for a hub; and
rivet holes;

7. The hub of claim 6, wherein the hub comprises a matching central hub in each washer.

8. The rivet holes of claim 6, wherein the pierced rivet holes comprise at least three rivet holes to maintain stability and shear strength in each washer throughout the assembly of the terbo.

9. The means of attaching the washers onto a unique gear blank of claim 4, wherein the means of attaching the washers onto a unique gear blank further comprises spot welding the washers together.

10. The means of roll-forming external teeth over the gear blank to create a terbo gear of claim 3, wherein the means of the roll-forming external teeth over the gear blank to create a terbo gear further comprises
mounting a machining fixture on a vertical milling machine, the vertical milling
machine comprising
two quill feed slides;
a collette assembly;
four quills;
handles controlling the motion of the four quills;
an X-Y axis table, such that the X-Y table can be locked into position;
a spindle;
an in-feed, such that the in-feed controls the movement of the quill feed slides;
four live centers, each live center comprising dual support bearings, an internal thrust bearing, and a shaft seal;
mounting a forming tool in a collette assembly in the quill of the vertical
milling machine;
retracting the quill feed slides;
loading two terbo gear blanks;
feeding the quills into the two terbo gear blanks such that the hubs of the two terbo gear blanks are set firmly against the live centers;
advancing the quill feed slides;
locking the X-Y axis table,
flooding the roll-forming area of the forming tool with cutting fluid;
presetting the spindle speed;
starting the milling machine, such that the forming tool turns in a clockwise rotation;
advancing the in-feed against the rotating forming tool;
reversing the milling machine, such that the forming tool turns in a clockwise rotation;
advancing the in-feed against the rotating forming tool again;
stopping the milling machine;
backing out the in-feet from the forming tool;
removing the terbo gears; and
removing the splay from the terbo gears in a lathe.

11. The machining fixture of claim 10, wherein the base of the machining fixture comprises a dovetail slide system to maintain precise movement of quill feed slides.

12. The forming tool of claim 10 wherein the forming tool comprises a mandrel containing an interchangeable roll-form insert.

13. The forming tool of claim 10, wherein the forming tool comprises a standard roll-form tap of jobber quality.
